(19) United States
(12) Patent Application Publication
(10) Pub. No.: US 2002/0105235 A1
(43) Pub. Date: Aug. 8, 2002

(54) Apparatus and method for controlling an electrical power supply

(76) Inventor: Peter Becker, Berlin (DE)

Correspondence Address: Peter G. Pappas, SUTHERLAND ASBILL & BRENNAN LLP, 999 Peachtree Street, NE, Atlanta, GA, 30309-3996, US

(21) Appl. No.: 10/060,860

(22) Filed: Jan. 30, 2002

(30) Foreign Application Priority Data
Feb. 6, 2001 (DE) 10105384.3-32

(51) Int. Cl. H01H 3/26

(52) U.S. Cl. 307/140

(57) ABSTRACT

The invention relates to an apparatus and a method for controlling an electrical power supply for operating an electrical appliance. The apparatus has a voltage input (20, 21) and a voltage output (22, 23) connected to it. A load measurement device (26) is used to determine an electrical measurement variable which is characteristic of an electrical voltage produced at the voltage output (22, 23). The electrical connection between the voltage input (20, 21) and the voltage output (22, 23) is switched by means of a load switching device (25) such that a standby voltage or an operating voltage is produced at the voltage output (22, 23). The load switching device (25) is controlled as a function of the determined electrical measurement variable such that the presence of the operating voltage at the voltage output (22, 23) is limited to a predetermined time period, and the standby voltage is produced at the voltage output (22, 23) at times which are not included in the predetermined time period.

The invention relates to an apparatus and a method for controlling an electrical power supply.

Electrical time switches are known which are used in order to enable a voltage or power supply for an electrical appliance for only a predetermined time period. Such electrical time switches are available as apparatuses which can be inserted into a domestic connecting plug socket, and have a receptacle for an appliance plug on the electrical appliance. The voltage available via the domestic supply, in particular a voltage of 220 V or 110 V, is in these cases passed on to the appliance plug only during a predetermined time period.

Known time switches have setting means for defining the time period or time intervals in which the operating or supply voltage is intended to be provided for the electrical appliance. Outside the predetermined time period or the defined time intervals, the voltage supply to the electrical appliance to be operated is interrupted.

The object of the invention is to provide an improved apparatus and an improved method for controlling an electrical power supply, which firstly allow the supply of an operating voltage or an operating current to an electrical appliance to be limited in time and secondly allow other voltages/currents, in particular a partial voltage/partial currents, to be provided to the electrical appliance at times when which the provision of the operating voltage/operating current is switched off.

This object is achieved according to the invention by an apparatus as claimed in claim 1 and by a method as claimed in claim 15.

A major advantage which the invention achieves in comparison to the prior art is that a standby voltage is available at the voltage output at times when which the electrical power supply is prevented by means of the load switching device, and is used to keep the electrical equipment that is to be operated in a standby mode. In modern electrical appliances, particularly in the case of electronic domestic appliances such as televisions or computers, components such as programming devices or display devices require a standby voltage even when the normal operating voltage of 220 V or 110 V is switched off. The invention ensures that these components can be operated without interruption.

The time limit for the provision of the operating voltage for the electrical appliance has the advantage that this makes it possible to limit the times during which the electronic appliance is used. For example, parents may wish to allow children to use the television or the computer for only a specific time period during the day. In this case, the predetermined time period may be composed of separate time intervals, so that the user of the electronic appliance can decide how the restricted, predetermined time period is distributed through the day. For the user, this leads to deliberate familiarity with the predetermined time period, which presets the total time period in which the operating voltage is available for the electrical appliance.

Exact and reliable determination of the electrical measurement variable is achieved, in one expedient development of the invention, by the load measurement device for determining the electrical measurement variable being an inductive measurement device.

The physical complexity and the effort to determine the electrical measurement variable can be minimized, in one expedient refinement of the invention, by the load measurement device being designed to carry out a threshold value measurement.

In order to make it possible for the monitoring device to reliably detect the time period in which the operating voltage is produced at the voltage output, one advantageous embodiment of the invention provides for the monitoring device to have a consumption timer device, which is connected to the load measurement device and has a counting device, with an electronic value of the counting device being continuously adapted during the predetermined time period in which the load measurement device indicates the presence of the operating voltage at the voltage output by means of electrical signals to the consumption timer device. Depending on the embodiment, this may be an increase or a decrease in the electronic value.

In order to use simple means to prevent the operating voltage from being produced at the voltage output once the predetermined time period has elapsed, one preferred development of the invention provides for the monitoring device to have signal means for producing a switch-off signal, which can be transmitted to the load switching device, when the consumption timer device finds that the electronic value of the counting device is equal to a maximum setting value.

In order to inform the user of the apparatus that the predetermined time period is about to elapse, one development of the invention provides for the monitoring device to be connected to a signal transmitter so that an electrical signal can be transmitted from the monitoring device to the signal transmitter when the electrical value of the counting device reaches a predetermined limit value.

One advantageous refinement of the invention provides for the monitoring device to have a 24-hour consumption timer device with a further counting device. This makes it possible to monitor the provision of the operating voltage as a function of a daily cycle.

In order to ensure efficient and functionally correct use of the timer device, one expedient embodiment of the invention can provide a control device for controlling the consumption timer device and the 24-hour consumption timer device.

In order to make it possible to enter a numerical or letter code, one development of the invention provides input means for inputting an identification code, with the input means being connected to the control device.

In order to prevent misuse of the apparatus, one expedient refinement of the invention provides a pushbutton device, which is connected to the control device, for setting the maximum setting value, in which case the input identification code can be evaluated electronically in the control device such that the pushbutton device can set the maximum setting value only if the input identification code corresponds to a predetermined identification code.

One advantageous development of the invention provides for the voltage output to be electrically connected to connecting means for holding appliance connecting means of an electrical appliance, with the connecting means having a locking mechanism which interacts with the control device such that the control device and the load switching device prevent the operating voltage being produced at the voltage output after a time at which the locking mechanism is unlocked. This ensures that the apparatus for controlling the electrical voltage supply can be used only in conjunction with that electrical appliance for whose use it has been set.

It is cost-effective for the locking mechanism to be in the form of a mechanical locking mechanism.

For electronic storage of the maximum setting value, memory means are provided in one advantageous embodiment of the invention. These means may be any desired electronic memory.

The method claims have advantages corresponding to those described in conjunction with the associated apparatus claims.

### The invention will be explained in more detail in the following text using an exemplary embodiment and with reference to a drawing, in which:

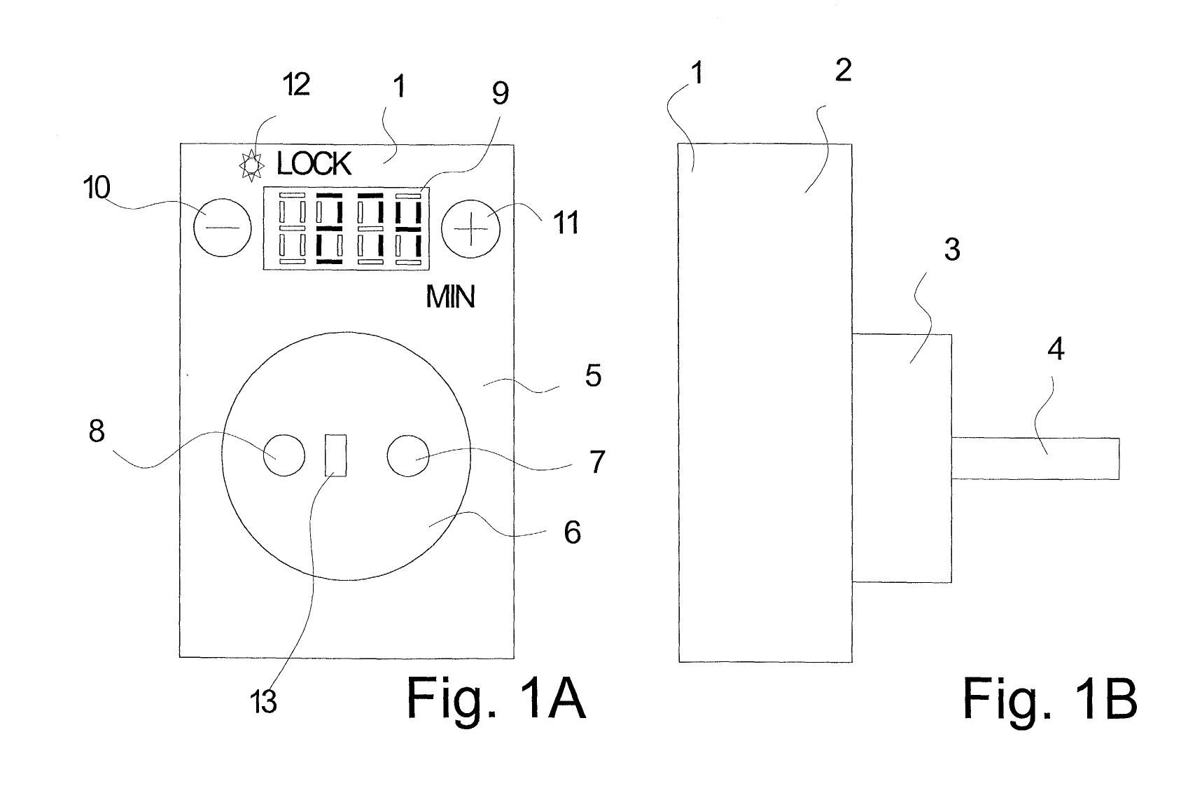

FIGS. 1A and 1B show a front and a side view of an apparatus for controlling a voltage supply, with the apparatus being in the form of a plug-on part for a plug socket;

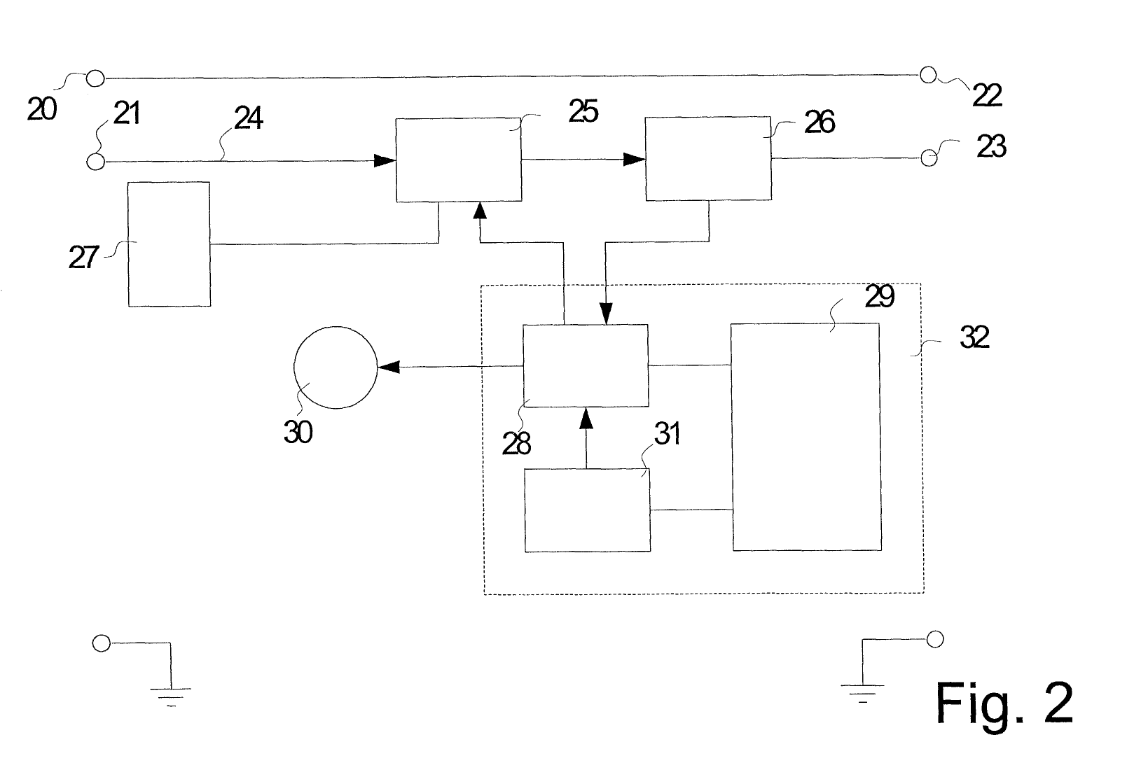

FIG. 2 shows a schematic block diagram to explain the method of operation of the apparatus shown in FIGS. 1A and 1B; and

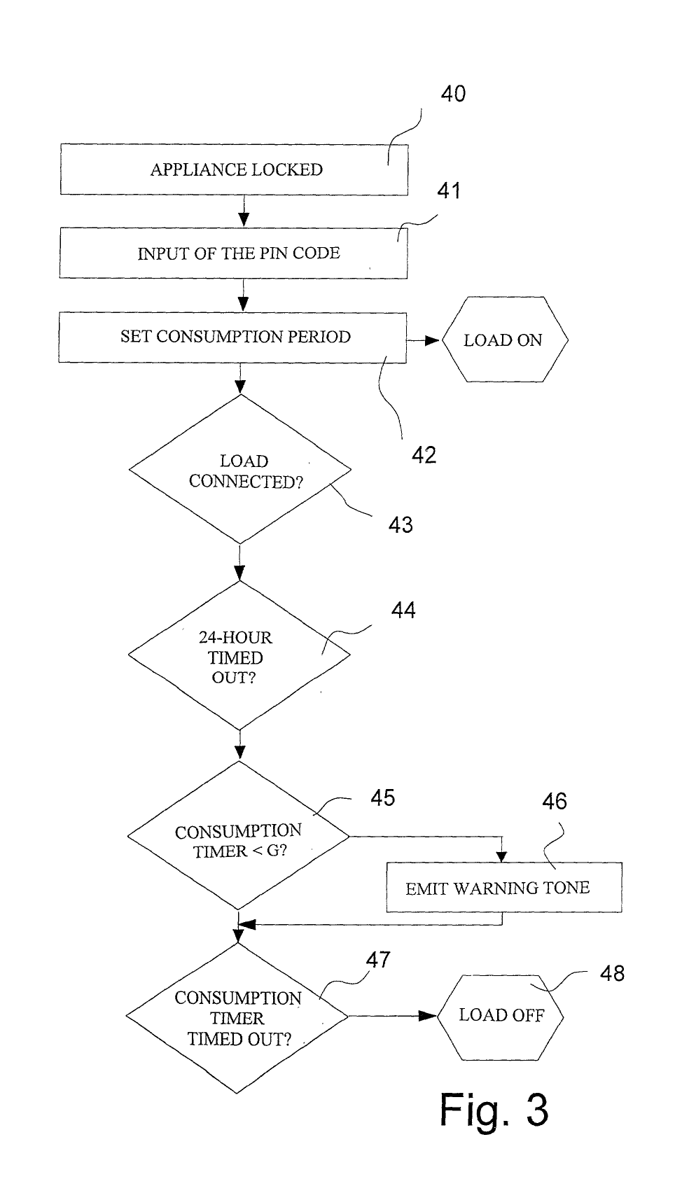

FIG. 3 shows a schematic flowchart to explain one method for controlling the voltage supply for an electrical appliance.

According to FIGS. 1A and 1B, a plug-in apparatus 1 has a front part 2 and a rear part 3. Plug pins 4 are arranged on the rear part 3. In order to use the plug-in apparatus 1 for controlling a voltage supply for an electrical appliance, the plug pins 4 are inserted into receptacles in a plug socket (not shown), so as to produce a connection to a voltage supply or source. A receptacle 6 for a plug from the electrical appliance to be operated is provided on a front face 5 of the front part 2. The receptacle 6 has two female plug connections 7, 8, into which plug pins on the plug of the electrical appliance to be operated are inserted, as well as protective ground contacts (not shown), as are normal in the case of domestic supply plug sockets. This makes it possible for the electrical voltage which is picked up by the plug-in apparatus 1 via the plug pins 4 to be transmitted partially or completely via the female plug connections 7, 8 to the plug pins of the inserted plug, and thus to the electrical appliance to be operated.

On the front face 5, the plug-in apparatus 1 also has a display device 9, setting means 10, 11, and a signaling device 12. In the area of the receptacle 6, there is a contact pin 13 which makes contact with the plug of the appliance to be operated during the insertion of said plug. The withdrawal of the plug, and the interruption of the contact with the contact pin 13 associated with this, lead to the plug-in apparatus 1 changing to a locked state, in which the operating voltage which is picked up via the plug pins 4 is not available at the female plug connections 7, 8. Any change to the locking state of the plug-in apparatus 1 such that the operating voltage can be available at the female plug connections 7, 8 once again requires resetting of the plug-in apparatus 1.

The plug-in apparatus 1 makes it possible to control the voltage supply for the electrical appliance to be operated whose plug is arranged in the receptacle 6, such that an operating voltage which is picked up via the plug pins 4 is available at the female plug connections 7, 8 only for a specific time period. The specific time period can in this case be subdivided into a number of individual time intervals which can be added together and in each of which the operating voltage is produced at the female plug connections 7, 8. When the plug-in apparatus 1 is connected to a plug socket of a domestic supply line, the operating voltage corresponds to the voltage available via the domestic supply mains system, for example 220 V or 110 V. This is generally that voltage which is required to operate the electrical appliance connected via the female plug connections 7, 8.

In time intervals in which the provision of the operating voltage at the female plug connections 7, 8 is suppressed, the electrical appliance is supplied with a standby voltage via the female plug connections 7, 8. This is a voltage which is sufficient, for example, to maintain the electrical appliance in a standby function (standby mode). The standby voltage makes it possible, for example, to operate display devices on the electrical appliance, such as those known on television sets or stereo systems.

FIG. 2 shows a block diagram of the components or assemblies in the plug-in apparatus 1 intended for controlling or regulating the voltage supply. The electrical/electronic components or assemblies which are provided can be designed using microprocessor technology and/or with a discrete circuit layout with conventional wiring, in which case the discrete circuit layout has the advantage over microprocessor technology that the voltage supply required to operate the components or the assemblies can be less stable. According to FIG. 2, voltage inputs 20, 21 are electrically connected to voltage outputs 22, 23. The voltage inputs 20, 21 are coupled in the plug-in apparatus 1 to the plug pins 4, while the voltage outputs 22, 23 are connected to the female plug connections 7, 8. A load switching device 25 as well as a measurement device 26 are coupled into an electrical connection 24 between the voltage input 21 and the voltage output 22. The load switching device 25 is used to switch the electrical voltage produced at the voltage outputs 22, 23 such that either the operating voltage or the standby voltage is produced when the voltage inputs 20, 21 are connected to a voltage source which provides at least the operating voltage. The load switching device 25 may be in the form of a relay or relays, or thyristors.

The measurement device 26 makes it possible to determine an electrical measurement variable which is characteristic of the electrical voltage produced at the voltage outputs 22, 23, namely the operating voltage or the standby voltage, so that the measured electrical measurement variable can be used to decide which of the two voltages is being produced at the voltage outputs 22, 23. In this case, the electrical measurement variable is preferably determined by means of an inductive measurement method. The measurement device 26 can be designed such that a threshold value measurement is carried out in such a way that, if the threshold value is exceeded, it is assumed that the operating voltage is in this case being produced at the voltage outputs 22, 23. If the electrical measurement variable is below the threshold value, it is assumed that the standby voltage is being produced at the voltage outputs 22, 23. In both cases, the measurement device 26 produces a respective signal, which indicates the presence of the operating voltage or of the standby voltage.

A power supply unit 27 provides the voltage supply required to operate the individual components and/or assemblies in the plug-in apparatus 1. The power supply unit 27 may be a transformer or a suitable circuit for a switch-mode power supply unit. A DC voltage of 12 V is normally provided by means of the switch-mode power supply unit 27.

A consumption timer 28 is used to determine the time period during which the operating voltage will be produced at the voltage outputs 22, 23. To do this, the consumption timer 28 is decremented electronically at predetermined time intervals, for example at intervals of one minute. The decrementation is always carried out only when the electrical measurement variable measured in the measurement device 26 indicates that the operating voltage is being produced at the voltage outputs 22, 23.

The time period during which the operating voltage may be available at the voltage outputs 22, 23 is defined electronically by means of a control device 29. This is done, for example, by appropriate programming of the control device 29. When the consumption timer 28 finds, during operation, that only a specific time remains of the previously defined time period in which the operating voltage may be produced at the voltage outputs 22, 23, the consumption timer 28 automatically produces a signal which is transmitted to a signal transmitter 30. As a reaction to the received signal, the signal transmitter 30 produces an audible and/or light signal, which indicates to the user of the plug-in apparatus 1 that the operating voltage will be produced at the voltage outputs 22, 23 only for the time which still remains.

If the consumption timer 28 finds that the time period, which is defined by means of the control device 29, for producing the operating voltage at the voltage outputs 22, 23 has elapsed, the load switching device 25 is switched in order to prevent the operating voltage from being passed on. In this case, the load switching device 25 reacts to a signal from the consumption timer 28. Once the load switching device 25 has been switched, the standby voltage continues to be available at the voltage outputs 22, 23 for as long as the voltage inputs 20, 21 are connected to the voltage source.

The passing on of the operating voltage is generally prevented when the voltage inputs 20, 21 are disconnected from the voltage supply after the plug-in apparatus 1 has been started up. This can occur, for example, as a result of the plug-in apparatus 1 being withdrawn from the domestic plug socket. However, a power failure can also lead to the plug-in apparatus 1 having to be reset or reprogrammed.

The predetermined time period in which the operating voltage is available at the voltage outputs 22, 23 can be set using the setting means 10, 11 (see FIG. 1A). The setting means 10, 11 are included in the control device 29 (see FIG. 2). The predetermined time period set by the user is displayed on the display device 9, can be lengthened or shortened using the setting means 10, 11, and is then stored in an electronic memory (not illustrated), which is preferably included in the control device 29.

The control device 29 is designed such that the setting means 11, 10 can be used to define the predetermined time period only once the user of the plug-in apparatus 1 has entered a PIN code, and a check has been carried out by the control device 29 to confirm that this matches a predetermined PIN code. This prevents unauthorized people, who do not know the PIN code, from being able to change the voltage supply control settings on the plug-in apparatus 1.

The invention furthermore provides for the operating voltage to be produced at the voltage outputs 22, 23 only for as long as the plug of the electrical appliance to be operated is arranged in the receptacle 6 (see FIG. 1A). To this end, the plug of the electrical appliance is locked in the receptacle 6, for example by means of a mechanical locking mechanism (not illustrated). The locking mechanism is operatively connected to the control device 29, so that the load switching device 25 is switched when the locking mechanism is released, such that the provision of the operating voltage at the voltage outputs 22, 23 is suppressed. Alternatively or in combination with the switching of the load switching device 25, it is possible to provide for the setting for definition of the predetermined time period to be erased or set to zero by means of the control device 29 when the locking mechanism is released, so that the operating voltage cannot be provided at the voltage outputs 22, 23.

According to FIG. 2, a 24-hour timer 31 is also connected to the control device 29 and to the consumption timer 28. The 24-hour timer 31 is decremented at fixed time intervals, for example every minute. In this way, the load switching device 25 can preferably be operated such that the time period predetermined by means of the control device 29 for the production of the operating voltage at the voltage outputs 22, 23 is possible only during a time interval of 24 hours. If the predetermined time period is not registered completely by means of the consumption timer 28 within 24 hours, then the time which still remains is lost, and is no longer available to the user of the plug-in apparatus 1. In another embodiment, it is possible to provide for the time which still remains still to be available after the 24 hour period has elapsed and to be added to a time credit which is provided for the time after the 24-hour period has elapsed. The time credit, including the remaining time that has been added, can be restricted to a maximum value.

The consumption timer 28, the 24-hour timer 31 and the control device 29 may be included in a monitoring device 32. This is indicated by means of a dashed line in FIG. 2.

A method for operating the plug-in apparatus 1 will be described in the following text with reference to FIG. 3. The plug-in apparatus 1 is initially in a locked state (see step 40), in which no voltage is produced at the voltage outputs 22, 23. Once the user of the plug-in apparatus 1 has input a PIN code (step 41), which is checked by means of the control device 29, the setting means 10, 11 (see FIG. 1A) can be used to set the predetermined time period (step 42) in which the operating voltage may be produced at the voltage outputs 22, 23. This is a total time period, which may be subdivided into a number of time intervals which can be accumulated.

The measurement device 26 is used to determine the electrical measurement variable which indicates whether the operating voltage or the standby voltage is being produced at the voltage outputs 22, 23 (see step 43 in FIG. 3). If the operating voltage is being produced at the voltage outputs 22, 23, an electronic count in the consumption timer 28 is increased. Furthermore, a continuous check is carried out to determine whether the 24-hour timer 31 has timed out (step 44). Once the consumption timer 28 has reached a previously defined limit value, a signal is produced and is transmitted to the signal transmitter 30 (step 45), so that it emits a warning tone and/or a warning light signal (step 46). If the consumption timer 28 finds that the predetermined time period has elapsed (step 47), it switches the load switching device 25 to prevent the operating voltage from being produced at the voltage outputs 22, 23 after this time (step 48).

The features of the invention disclosed in the above description, in the drawing and in the claims may be significant to the implementation of the various embodiments of the invention both individually and in any combination.

What is claimed is:

1. An apparatus for controlling an electrical power supply having:
a voltage input (20, 21) which can be connected to an electrical voltage source;
a voltage output (22, 23) which is connected via an electrical connection to the voltage input (20, 21) and can be connected to an electrical appliance;
a load measurement device (26) for determining an electrical measurement variable which is characteristic of an electrical voltage produced at the voltage output (22, 23);
a load switching device (25) for switching the electrical connection between the voltage input (20, 21) and the voltage output (22, 23) such that a standby voltage or an operating voltage is produced at the voltage output (22, 23) after the connection of the voltage input (20, 21) to a voltage source; and
a monitoring device (29), which is connected to the load measurement device (26) and to the load switching device (25), for electronic processing of the electrical measurement variable which is determined by means of the load measurement device (26), such that the load switching device (25) can be operated by means of the monitoring device (32) as a function of the time profile of the determined electrical measurement variable such that the production of the operating voltage at the voltage output (22, 23) is limited to a predetermined time period, and the standby voltage is produced at the voltage output (22, 23) at times which are not included in the predetermined time period.

2. The apparatus as claimed in claim 1, wherein the load measurement device (26) for determining the electrical measurement variable is an inductive measurement device.

3. The apparatus as claimed in claim 1, wherein the load measurement device (26) is designed to carry out a threshold value measurement.

4. The apparatus as claimed in claim 1, wherein the monitoring device (32) has a consumption timer device (28), which is connected to the load measurement device (26) and has a counting device, with an electronic value of the counting device being continuously adapted during the predetermined time period in which the load measurement device (26) indicates the presence of the operating voltage at the voltage output (22, 23) by means of electrical signals to the consumption timer device (28).

5. The apparatus as claimed in claim 1, wherein the monitoring device (32) has signal means for producing a switch-off signal, which can be transmitted to the load switching device (25), when the consumption timer device (28) finds that the electronic value of the counting device is equal to a maximum setting value.

6. The apparatus as claimed in claim 1, wherein the monitoring device (32) is connected to a signal transmitter (30) so that an electrical signal can be transmitted from the monitoring device (32) to the signal transmitter (30) when the electrical value of the counting device reaches a predetermined limit value.

7. The apparatus as claimed in claim 1, wherein the monitoring device (32) has a 24-hour consumption timer device (31) with a further counting device.

8. The apparatus as claimed in claim 1, distinguished by a control device (29) for controlling the consumption timer device (28) and the 24-hour consumption timer device (31).

9. The apparatus as claimed in claim 8, distinguished by input means for inputting an identification code, with the input means being connected to the control device (29).

10. The apparatus as claimed in claim 9, distinguished by a push-button device (10, 11), which is connected to the control device (29), for setting the maximum setting value, in which case the input identification code can be evaluated electronically in the control device (29) such that the pushbutton device (10, 11) can set the maximum setting value only if the input identification code corresponds to a predetermined identification code.

11. The apparatus as claimed in claim 8, wherein the voltage output (22, 23) is electrically connected to connecting means (6, 7, 8) for holding appliance connecting means of an electrical appliance, with the connecting means having a locking mechanism which interacts with the control device (29) such that the control device (29) and the load switching device (25) prevent the operating voltage being produced at the voltage output (22, 23) after a time at which the locking mechanism is unlocked.

12. The apparatus as claimed in claim 11, wherein the locking mechanism is a mechanical locking mechanism.

13. The apparatus as claimed in claim 5, distinguished by memory means for electronic storage of the maximum setting value.

14. The apparatus as claimed in claim 1, wherein the apparatus is in the form of a plug-on part (1) for a plug socket for a domestic supply.

15. A method for controlling a power supply, which method comprises the following method steps:
switching of an electrical connection (24) between a voltage input (20, 21) and a voltage output (22, 23) by means of a load switching device (25) such that a standby voltage or an operating voltage is produced at the voltage output (22, 23) when the voltage input (20, 21) is connected to an electrical voltage source;
monitoring of the electrical connection (24) between a voltage input (20, 21) and a voltage output (22, 23) by means of a load measurement device (26), in order to determine an electrical measurement variable which is characteristic of a voltage produced at the voltage output (22, 23); and
control of the load switching device (25) by means of a monitoring device (32) as a function of a time profile of the determined electrical measurement variable, such that the presence of the operating voltage at the voltage output (22, 23) is limited to a predetermined time period, and the standby voltage is produced at the voltage output (22, 23) at times which are not included in the predetermined time period.

16. The method as claimed in claim 15, wherein, in order to define the predetermined time period, a maximum setting value which is entered using input means is detected electronically.

17. The method as claimed in claim 15, wherein, at a defined time before the predetermined time period is reached, an electrical signal is transmitted from the monitoring device (32) to a signal transmitter (30), and, as a reaction to the electrical signal, the signal transmitter (30) produces a visual and/or an audible signal.

18. The method as claimed in claim 15, wherein an electronic value of a counting device is increased continuously during the predetermined time period, with the counting device being included in a consumption timer device (28), which is connected to the load measurement device (26), for the monitoring device (32).
